(19) United States
(12) Patent Application Publication
(10) Pub. No.: US 2024/0254667 A1
(43) Pub. Date: Aug. 1, 2024

(54) Upholstery Material for Seat and Seat Including Same

(71) Applicant: Asahi Kasei Kabushiki Kaisha, Tokyo (JP)

(72) Inventor: Naoki Yanagita, Tokyo (JP)

(73) Assignee: Asahi Kasei Kabushiki Kaisha, Tokyo (JP)

(21) Appl. No.: 18/566,148

(22) PCT Filed: May 30, 2022
(86) PCT No.: PCT/JP2022/021966

§ 371 Date: Dec. 1, 2023

(30) Foreign Application Priority Data
Jun. 1, 2021 (JP) 2021-092305

(51) Int. Cl. D04B 21/20; A47C 31/00; B60N 2/58; D04B 21/16

(52) U.S. Cl. CPC D04B 21/20; A47C 31/00; D04B 21/16; B60N 2/58; D10B 2331/04; D10B 2403/022; D10B 2403/033; D10B 2505/08

(57) ABSTRACT

Provided is an upholstery material for a seat for vehicles, furniture, etc., wherein the material has excellent designability due to having concave deformed parts, and at the same time can suppress the occurrence of fluffing even if the surface is rubbed by hard protrusions such as hooks of hook-and-loop fasteners, and has excellent cushioning due to suppressing sideways falling. The surface material for a seat according to the present invention is constituted of a three-dimensional knitted fabric comprising a two-layered knitted fabric having a surface layer and a back layer, and a connecting thread that connects the layers of the two-layered knitted fabric, and the surface material is characterized in that the three-dimensional knitted fabric has concave deformed parts on the surface-layer side, and a parameter A, calculated by the formula: parameter A=course density (course/2.54 cm)×concave part thickness (mm)/fabric thickness (mm), is 6-36 (inclusive).

### FIELD

The present invention relates to a surface covering (or an upholstery) material for a seat and a seat comprising the same.

### BACKGROUND

Conventionally, three-dimensional knitted materials composed of a front-back two-layered knitted fabric and connecting yarns connecting the layers of two-layered knitted fabric have cushioning properties in the thickness direction by using monofilaments as the connecting yarns, and are widely used as a cushioning material having cooling and high dampness prevention properties in applications such as seats and bedding by using a mesh structure on the front and back sides of the knitted fabric to ensure high breathability.

When a three-dimensional knitted material is used as an surface material of a seat, high designability is exhibited by forming irregularities on the front side of the above cushioning material by heat embossing. However, durability such as surface abrasion resistance and cushioning properties required for a seat are inferior.

The following PTL 1 discloses that a sheet material having a gradation from a recessed portion to a non-recessed portion and excellent designability can be obtained by having a gradual changing portion in which the height from the bottom of the recessed portion gradually changes from the recessed.

### CITATION LIST

### Patent Literature

[PTL 1] Japanese Unexamined Patent Publication (Kokai) No. 2019-104217

### SUMMARY

### Technical Problem

In PTL 1, the surface condition for suppressing fluff due to wear and the formation of recessed portions for suppressing a sideways falling phenomenon were not considered, and the suppression performance of fluff due to rubbing against protrusions and the cushioning properties obtained by suppressing the sideways falling phenomenon were insufficient.

In view of the above state of the prior art, an object to be achieved in the present invention is to solve the above problems of the prior art and provide an surface material for seats of vehicles and furniture that has excellent designability by including a recess-shaped deformation portion and can suppress occurrence of fluff at the same time, even when the surface is rubbed by hard protrusions such as hook portions of a hook-and-loop fastener, and has excellent cushioning properties by suppressing a sideways falling phenomenon, and a seat comprising the same.

### Solution to Problem

The present inventors have undergone intensive studies and repeated experiments to achieve the above object. As a result, the present inventors have unexpectedly discovered that the above object can be achieved by an surface material for a seat, consisting of a three-dimensional knitted material composed of a front-back two-layered knitted fabric and a connecting yarn connecting layers of the two-layered knitted fabric, wherein a recess-shaped deformation portion is formed on the front side of the three-dimensional knitted material and a parameter A calculated from course density, thickness of the deformation portion (recessed portion) and fabric thickness of the three-dimensional knitted material is set within a specific range, and have completed the present invention.

Specifically, the present invention is as follows.

A surface material for a seat, composed of a three-dimensional knitted material comprising a front-back two-layered knitted fabric having a front layer and a back layer and a connecting yarn connecting layers of the front-back two-layered knitted fabric, wherein the three-dimensional knitted material includes a recessed deformation portion on at least one of the layers, and a parameter A calculated by the following formula:

$$parameter A = course density ( courses / 2.54 cm ) \times recessed portion thickness ( mm ) / fabric thickness ( mm )$$

is 6 or greater and 36 or less.

The surface material for a seat according to the above [1], wherein the recessed deformation portion is formed across 5 or more continuous wales.

The surface material for a seat according to the above [1] or [2], wherein the recessed deformation portion is formed continuously across 60 courses or less on a same wale.

The surface material for a seat according to any of the above [1] to [3], wherein the three-dimensional knitted material includes a plurality of recessed deformation portions, and a spacing between recessed deformation portions closest to each other on a same wale is 10 mm or more and less than 300 mm.

The surface material for a seat according to the above [4], wherein a spacing between recessed deformation portions closest to each other on a same wale is 15 mm or more and less than 300 mm.

The surface material for a seat according to any of the above [1] to [4], wherein the recessed deformation portion is formed by fusion of fibers.

The surface material for a seat according to the above [5], wherein the recessed deformation portions are formed by fusion of fibers.

The surface material for a seat according to any of the above [1] to [5], wherein the recessed deformation portion is formed by embroidery or sewing.

The surface material for a seat according to any of the above [1] to [8], wherein a stitch density in a front layer of the three-dimensional knitted material is 11500 or greater and 23000 or less.

The surface material for a seat according to the above [9], wherein a stitch density in a front layer of the three-dimensional knitted material is 13000 or greater and 23000 or less.

A seat comprising the surface material for a seat according to any of the above [1] to [10].

### Advantageous Effects of Invention

The surface material for a seat of the present invention has excellent designability by including a recess-shaped deformation portion and can suppress occurrence of fluff at the same time, even when the surface is rubbed against hard protrusions such as hook portions of a hook-and-loop fastener, and has excellent cushioning properties by suppressing a sideways falling phenomenon.

### BRIEF DESCRIPTION OF DRAWINGS

FIG. 1 is a diagram showing recessed deformation portions of Examples 1, 2, 3, 6, 9, 10, 11, and 15 and Comparative Examples 1 and 2.

FIG. 2 is a diagram showing recessed deformation portions of Examples 4, 7, and 12.

FIG. 3 is a diagram showing recessed deformation portions of Examples 5 and 13.

FIG. 4 is a diagram showing recessed deformation portions of Examples 8 and 14.

### DESCRIPTION OF EMBODIMENTS

Hereinafter, embodiments of the present invention will be described in detail.

One of the embodiments of the present invention is an surface material for a seat, composed of a three-dimensional knitted material comprising a front-back two-layered knitted fabric having a front layer and a back layer and a connecting yarn connecting layers of the front-back two-layered knitted fabric, wherein the three-dimensional knitted material includes a recessed deformation portion on at least one of the layers, and a parameter A calculated by the following formula:

$$parameter A = course density ( courses / 2.54 cm ) \times recessed portion thickness ( mm ) / fabric thickness ( mm )$$

is 6 or greater and 36 or less.

The surface material for a seat of the present embodiment comprises a three-dimensional knitted material composed of a front-back two-layered knitted fabric and a connecting yarn connecting the layers of the two-layered knitted fabric. The three-dimensional knitted material is knitted by a double Raschel warp knitting machine or a double circular knitting machine. For the gauge of the knitting machine, 18- to 28-gauge is preferably used.

It is necessary for the three-dimensional knitted material constituting the surface material for a seat of the present embodiment to include a recess-shaped deformation portion on at least one of the layers. By including one or a plurality of the recessed deformation portions, the surface material of the present embodiment exhibits an excellent three-dimensional design. The recessed deformation portion refers to a thin portion formed on the surface of the three-dimensional knitted fabric by heat or pressure causing plastic deformation and fusion of fibers or by embroidery or sewing. Any other thin portions resulting from conformity to the above portion are excluded from the recessed deformation portion. A recessed deformation portion formed by fusion of fibers is typically formed by heat pressing. A recessed deformation portion formed by embroidery or sewing can be formed using any yarn or method, and depending on the pattern and the stitch shape, embroidery machines, lockstitch sewing machines, and zigzag sewing machines can be used. The recessed deformation portion is preferably formed by fusion of fibers from the viewpoint of suppressing fluff due to protrusions, or is preferably formed by embroidery or sewing from the viewpoint of obtaining more satisfactory cushioning properties by suppressing a sideways falling phenomenon.

In the three-dimensional knitted material constituting the surface material for a seat of the present embodiment, it is necessary for a parameter A calculated by the following formula:

$$parameter A = course density ( courses / 2.54 cm ) \times recessed portion thickness ( mm ) / fabric thickness ( mm )$$

to be 6 or greater and 36 or less.

When the parameter A is less than 6, stitches on the front layer are coarse and the change in thickness from a non-deformation portion to a deformation portion is large, decreasing the contact area during compression and concentrating the pressure, whereby protrusions such as hook portions of a hook-and-loop fastener are more easily caught in single fibers of the stitches on the front layer and the single fibers are more easily cut and fluffed. In contrast, when the parameter A exceeds 36, it is more difficult for protrusions such as hook portions of a hook-and-loop fastener to be caught on single fibers of the stitches on the front layer. However, since the front layer is smoothened, slipping of a seated person's buttocks cannot be prevented. In addition, since the angle formed between the connecting yarn connecting the layers of the front-back two-layered knitted fabric and the fabric thickness direction decreases and the connecting yarn is not fixed at the recessed deformation portion, the sideways falling phenomenon cannot be suppressed and the cushioning properties degrade.

From the viewpoint of suppressing fluff due to protrusions, the range of the parameter A is preferably 8 or greater, and more preferably 10 or greater. From the viewpoint of preventing slipping of a seated person's buttocks and the viewpoint of obtaining more satisfactory cushioning properties by suppressing a sideways falling phenomenon, the range of the parameter A is preferably 30 or less, and more preferably 24 or less.

In order to set the parameter A to 6 or greater and 36 or less, when knitting the three-dimensional knitted material, it is preferable to adjust the fineness of the fibers used, the gauge of the knitting machine, the on-machine course, the knit structure, and the width-in rate, width-out rate, overfeed rate, and underfeed rate in a finishing process such as heat setting, and when forming a recess-shaped deformation portion on the front side of the three-dimensional knitted material, it is preferably to adjust the heating time, the cradle temperature, the press die shape, the press die temperature, and the press pressure when deformation by heating is used. Low-melting-point yarns or heat-fusible yarns can be used. When using other methods of forming a deformation, the recessed portion can be formed by embroidery. In that case, it is preferable to adjust the type of sewing yarn, the fineness, the embroidery pattern, the sewing machine needle, the sewing width, and the stitch pitch.

The sideways falling phenomenon is likely to occur when the knitted fabric of the front layer moves in the warp direction of the knitted fabric relative to the knitted fabric of the back layer during compression of the three-dimensional knitted material. In the three-dimensional knitted material constituting the surface material for a seat of the present embodiment, a recessed deformation portion is formed preferably across 5 or more continuous wales, and more preferably across 10 or more wales. When formed across 5 or more wales, movement of the front-layer knitted fabric in the knitted fabric warp direction is easily prevented by the recessed deformation portion, and the sideways falling phenomenon is easily suppressed.

In the three-dimensional knitted material constituting the surface material for a seat of the present embodiment, the recessed deformation portion is formed continuously on the same wale across preferably 60 courses or less, and more preferably 40 courses or less. When the recessed deformation portion is formed continuously on the same wale across 60 courses or less, deterioration in cushioning properties during seating due to local changes in compression characteristics caused by the recessed deformation portion is not likely to occur.

When the three-dimensional knitted material constituting the surface material for a seat of the present embodiment includes a plurality of recessed deformation portions, a spacing in the knitted fabric warp direction between recessed deformation portions closest to each other on the same wale is preferably 10 mm or more and less than 300 mm, and more preferably 15 mm or more and 250 mm or less. When the spacing in the knitted fabric warp direction between recessed deformation portions is 10 mm or more, deterioration in cushioning properties between the recessed deformation portions is more easily suppressed, and since the curvature of the protruding portion between the recessed deformation portions is increased, fluff due to protrusions is more easily suppressed. When the spacing in the knitted fabric warp direction between recessed deformation portions is less than 300 mm, in particular, movement of the front-layer knitted fabric in the knitted fabric warp direction between the recessed deformation portions is effectively suppressed, and the sidesways falling phenomenon is more easily suppressed.

For the three-dimensional knitted material constituting the surface material for a seat of the present embodiment, the stitch density in the knitted fabric of the front layer on the seating front side of the surface material for a seat is preferably 11500 or greater and 20000 or less.

The term “stitch density” herein, represented by the following formula:

$$stitch density M = N \times √ D$$

wherein N is the number of stitches per 2.54 cm in the knitted fabric of the front layer, and D is the total fineness (decitex) of fibers forming one stitch in the knitted fabric of the front layer, is an index indicating the denseness of stitches of the knitted fabric of the front layer. Additionally, the “total fineness of fibers forming one stitch in the knitted fabric of the front layer” refers to the total fineness of only the fibers that form stitches, and fibers that do not form stitches, such as those of inlay knitting, are excluded therefrom.

When the stitch density is 11500 or greater, protrusions such as hook portions of a hook-and-loop fastener are less likely to be caught on single fibers of the stitches on the front layer, and the single fibers are less likely to be cut and fluffed.

From the viewpoint of suppressing fluff due to protrusions, the range of the stitch density is more preferably 13000 or greater and 23000 or less, and even more preferably 14000 or greater and 23000 or less.

In order to set the stitch density to 11500 or greater and 23000 or less, it is preferable to adjust the fineness of the fibers used in the knitted fabric of the front layer, the gauge of the knitting machine, the on-machine course, the knit structure, and the width-in rate, width-out rate, overfeed rate, and underfeed rate in a finishing process such as heat setting.

The material of the fibers used in the knitted fabric of the front layer is not limited, and may be a single material or a plurality of material composited by blending, twisting, mixed spinning, or interweaving. However, filaments of polyethylene terephthalate fibers are preferably used in terms of yarn strength and light fastness. From the viewpoint of increasing pull-out resistance of single fibers so that pulling out single fibers from the knitted fabric surface by protrusions such as hook portions of a hook-and-loop fastener is more difficult, the polyethylene terephthalate fibers are preferably false-twisted yarns, interlaced yarns, or twisted yarns.

Regarding the fineness of the fibers used in the knitted fabric of the front layer, fibers having a fineness of 100 decitex or more and 350 decitex or less are preferably used in order to optimize the stitch density. From the same viewpoint, the total fineness of one stitch consisting of fibers forming the knitted fabric of the front layer is preferably 150 decitex or more and 800 decitex or less.

When the fibers used in the knitted fabric of the front layer are multifilaments, the single-yarn fineness thereof is preferably 1 decitex or more and 6 decitex or less, and more preferably 3 decitex or more and 6 decitex or less to further increase the strength of a single yarn.

The fiber used for the connecting yarn is preferably a monofilament. When a monofilament is used for the connecting yarn, the fineness thereof is preferably 30 decitex or more and 300 decitex or less, and more preferably 50 decitex or more and 250 decitex or less to suppress protrusion of the monofilament onto the knitted fabric surface and maintain satisfactory cushioning properties.

Since the monofilament is easily caught on protrusions such as hook portions of a hook-and-loop fastener when protruding from the knitted fabric surface of the three-dimensional knitted material, it is desirable that the stitches of the fibers forming the knitted fabric of the front layer be pressed down on the monofilament stitches so that the monofilament does not protrude to the outside surface (i.e., seating surface of the surface material for a seat) of the knitted fabric of the front layer. Thus, it is preferable that the fineness D2 (decitex) of the monofilament relative to the fineness D1 (decitex) of one stitch consisting of fibers forming the knitted fabric of the front layer satisfy the following relational expression:

$$D 1 / D 2 \geq 3.$$

Any material can be used for the fibers constituting the three-dimensional knitted material, and various fiber materials may be composited. However, it is preferable that the knitted fabric of the front layer, the connecting yarn, and the knitted fabric of the back layer be made of 100% polyethylene terephthalate fibers in terms of ease of recycling, such as material recycling and chemical recycling. Although these fibers may be undyed, a dope-dyed yarn or yarn-dyed yarn is preferably used to suppress variations in the properties of the three-dimensional knitted material during a dyeing process. A dope-dyed yarn kneaded with a pigment that can eliminate the need for a dyeing process is more preferably used.

The thickness of the three-dimensional knitted material constituting the surface material for a seat of the present embodiment can be arbitrarily set, but from the viewpoints of sewing and handling as an surface material and cushioning properties, is preferably 3 mm or more and 12 mm or less, and more preferably 3 mm or more and 8 mm or less. The basis weight of the three-dimensional knitted material can also be arbitrarily set, but is preferably 400 to 1000 g/m², and more preferably 500 to 900 g/m².

Regarding the finishing method for the three-dimensional knitted material constituting the surface material for a seat of the present embodiment, in the case of a three-dimensional knitted material using a yarn-dyed yarn or dope-dyed yarn, a gray fabric can be finished through processes such as scouring and heat setting, but is more preferably finished by heat setting only in terms of process simplification. In the case of a three-dimensional knitted material in which either the connecting yarn or the fibers used in the front-back two-layered knitted fabric are uncolored, the gray fabric can be finished through processes such as presetting, scouring, dyeing, and heat setting.

The surface material for a seat of the present embodiment is used for a seat, and can be laminated with urethane on the back surface of the seating surface as in conventional seat surface materials, but is preferably used without the lamination in terms of recyclability. The surface material for a seat of the present embodiment may be composed of a three-dimensional knitted material alone, but in terms of designability and functionality, may be composed in combination with other materials by sewing.

### EXAMPLES

Hereinafter, the present invention will be more specifically described by way of the Examples and Comparative Examples. However, the present invention is not limited to the Examples only.

Methods for measuring various physical properties of the three-dimensional knitted materials used in the Examples were as follows.

### (a) Parameter A

The course density (number of courses/2.54 cm) of a three-dimensional knitted material was visually measured. In addition, the thickness (mm) of the recessed deformation portion and the thickness (mm) of the non-deformation portion were measured. When a three-dimensional knitted material included a plurality of recessed deformation portions having different thicknesses, or when the thickness varied depending on the position on a recessed deformation portion, the thickness of the recessed portion was at a portion where the thickness was the smallest. For the fabric thickness, the thickness was measured at a portion where the effect of the recessed deformation portion on the fabric thickness was as small as possible. In other words, the fabric thickness was at a portion where the thickness of the three-dimensional knitted material was the largest. Thickness was measured using a thickness gauge under a pressure of 0.7 kPa. Further, the thickness of the recessed deformation portion was measured when the above pressure was applied only to the recessed deformation portion.

Using the course density, the thickness of the recessed deformation portion, and the fabric thickness as described above, a parameter A was calculated by the following formula:

$$parameter A = course density ( courses / 2.54 cm ) \times recessed portion thickness ( mm ) / fabric thickness ( mm ) .$$

### (b) Stitch Density in Knitted Fabric of Front Layer

Yarns were extracted from the knitted fabric of the front layer of the three-dimensional knitted material, and the total fineness D (decitex) of the fibers forming one stitch of the knitted fabric of the front layer was measured. At this time, connecting yarns were not included. The product N of the number of courses per 2.54 cm and the number of wales per 2.54 cm of the three-dimensional knitted material was determined, and the stitch density in the knitted fabric of the front layer was calculated by the following formula:

$$stitch density M = N \times √ D .$$

### (c) Number of Wales Having Formed Thereon Recessed Deformation Portion

A three-dimensional knitted material was cut into a size of 40 cm×40 cm, one recessed deformation portion was extracted at random, and the number of wales having formed thereon the recessed deformation portion was visually counted. At this time, when the recessed deformation portion was formed across a plurality of courses, the total number of wales across the plurality of courses was counted instead of counting only the number of wales on the same course.

When the recessed deformation portion spanned the entire width of the cut three-dimensional knitted fabric, the number of wales in the entire width at the time of the three-dimensional knitting was the number of wales forming the recessed deformation portion.

### (d) Number of Courses Having Formed Thereon Recessed Deformation Portion on Same Wale

A three-dimensional knitted material was cut into a size of 40 cm×40 cm, one recessed deformation portion was extracted at random, and the number of courses having formed thereon the recessed deformation portion on the same wale was visually counted.

### (e) Spacing in Knitted Fabric Warp Direction Between Recessed Deformation Portions Closest to Each Other on Same Wale

A three-dimensional knitted material was cut into a size of 40 cm×40 cm, recessed deformation portions closest to each other on the same wale were extracted, and the spacing between the recessed deformation portions in the knitted fabric warp direction was visually measured using a ruler.

### (f) Fluff Due to Hook-and-Loop Fastener (Grade)

Using a flat abrasion tester manufactured by Daiei Kagaku Seiki Mfg. Co., a three-dimensional knitted material having a test piece size of 8 cm in width and 31 cm in length was placed on a flat abrasion table of the flat abrasion tester with the knitted fabric of the front layer facing upward, and both ends were fixed with clamps. Magic Tape™ A8693Y.71 (length of 5 cm) was then attached to a rubbing element with the hook side facing outward. The rubbing element was set on the test piece, and a wear test was carried out 5 times at a pressing load of 9.8 N including the rubbing element, a stroke of 14 cm, and a speed of 60±10 reciprocations/min. Test pieces were collected from the vertical and horizontal directions of the three-dimensional knitted material and measured. After the test, the wear condition on the surface of the test piece was observed, and a grade was determined based on the following criteria. Determinations were made in 0.5-grade increments.
Grade 5: No fluff was visible.
Grade 4: Fluff was slightly visible.
Grade 3: Fluff was clearly visible, but yarn breakage was not noticeable.
Grade 2: Fluff was somewhat significant, and there were yarn breakage and “pulling-out” of yarns.
Grade 1: Fluff was significant, and there were severe abnormalities in appearance.

### (g) Cushioning Properties

The surface material was stretched over urethane pads on the seat portion and back portion of an automobile seat, and a seat in which the entire surface of the seat in contact with a human body was formed of the surface material composed of a three-dimensional knitted material was produced.

A grade was determined for how a monitor sitting on the seat felt about cushioning based on the following criteria and taken as an evaluation of cushioning properties. Determinations were made in 0.5-grade increments.
Grade 5: There was firm cushioning, and it was comfortable.
Grade 4: There was cushioning, and it was somewhat comfortable.
Grade 3: There was some cushioning, but it was not comfortable.
Grade 2: There was slight cushioning, and it was somewhat uncomfortable.
Grade 1: There was no cushioning, and it was uncomfortable

### (h) Slipperiness

A grade was determined for how a monitor sitting on the seat felt about slipperiness against the buttocks based on the following criteria and taken as an evaluation of slipperiness. Determinations were made in 0.5-grade increments.
Grade 5: There was no slipping at all; secure gripping was felt.
Grade 4: There was almost no slipping; gripping was felt.
Grade 3: Slipping was somewhat difficult.
Grade 2: Slipping was somewhat easy; not much gripping was felt.
Grade 1: Slipping was considerably easy; no gripping was felt at all.

### (i) Sideways Falling Properties

A surface material cut into a square having a length of 40 cm on one side was arranged on a horizontal tabletop with the front layer facing up, and based on the following criteria, a grade was determined for sideways falling properties when the surface material was pushed by hand from above and taken as an evaluation of sideways falling properties. Determinations were made in 0.5-grade increments.
Grade 5: No sideways falling occurred at all.
Grade 4: Sideways falling occurred slightly.
Grade 3: Sideways falling occurred.
Grade 2: Sideways falling occurred considerably.
Grade 1: Sideways falling occurred very easily; no recovery occurred after compression.

### Examples 1 to 7

Using a 22-gauge double Raschel knitting machine equipped with 6 reeds and 6 mm trick plate distance, two false-twisted yarns of 167-decitex 48-filament polyethylene terephthalate fibers (black dope-dyed yarns) were pulled from two reeds (L1, L2) forming the knitted fabric of the front layer and fed in 1-in, 1-out (L1) and 1-out, 1-in (L2) arrangements, monofilaments of 110-decitex polyethylene terephthalate fibers (black dope-dyed yarns) were then fed from one reed (L3) forming a connecting portion in a 1-out, 1-in (L3) arrangement, and false-twisted yarns of 167-decitex 48-filament polyethylene terephthalate fibers (black dope-dyed yarns) were further fed from two reeds (L5, L6) forming the knitted fabric of the back layer, both in an all-in arrangement, to knit a three-dimensional knitted material gray fabric.

The three-dimensional knitted material gray fabric was knitted with a knit structure indicated below at an on-machine course of 33 courses/2.54 cm. The resulting gray fabric was drawn in width by 1% and subjected to dry heat setting at 175° C.×1 min at an overfeed rate of 0%, followed by heat pressing for 6 s from the front layer side at a press die temperature of 200° C. using a press die designed as indicated below to obtain a three-dimensional knitted material including recessed deformation portions having the various physical properties in Table 1 below, and was used as an surface material for a seat.

### (Knit Structure)

L1: 1011/2322/(1-in, 1-out)
L2: 2322/1011/(1-out, 1-in)
L3: 3410/4367/(1-out, 1-in)
L4: - (yarn not fed)
L5: 0001/1110/(all-in)
L6: 2234/2210/(all-in)

### (Press Die Design)

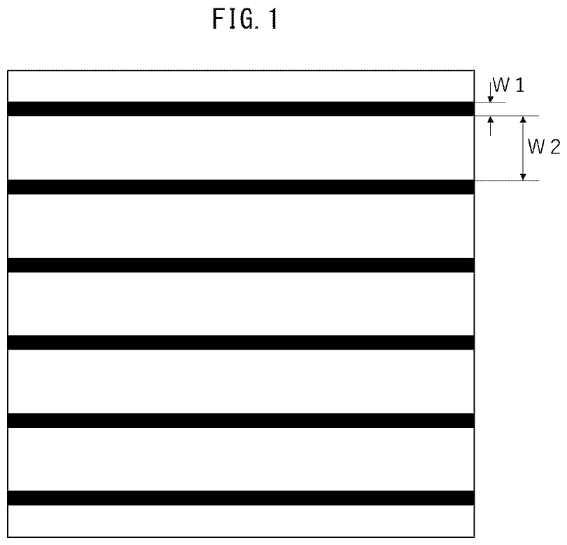

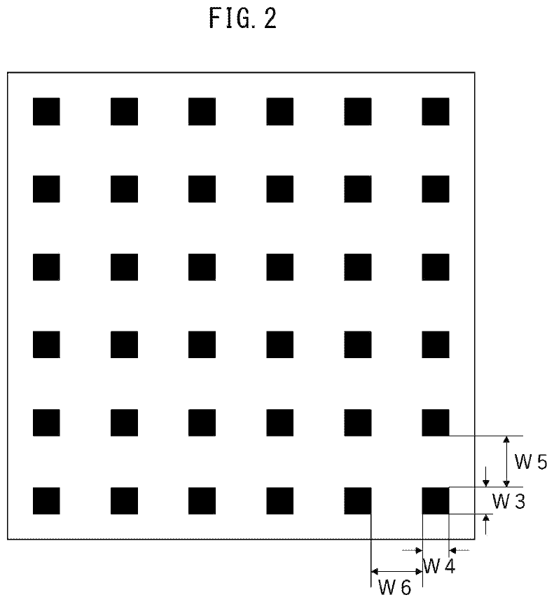

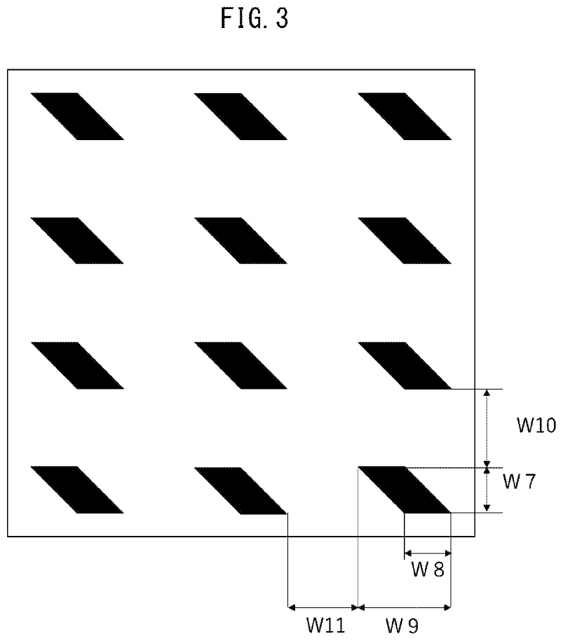

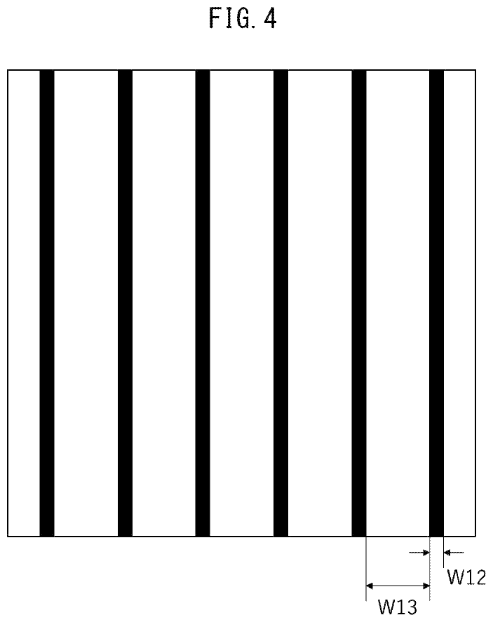

Example 1: Refer to FIG. 1 (W1: 1 mm, W2: 12 mm).
Example 2: Refer to FIG. 1 (W1: 2 mm, W2: 16 mm).
Example 3: Refer to FIG. 1 (W1: 7 mm, W2: 38 mm).
Example 4: Refer to FIG. 2 (W3: 5 mm, W4: 5 mm, W5: 5 mm, W6: 5 mm).
Example 5: Refer to FIG. 3 (W7: 35 mm, W8: 35 mm, W9: 70 mm, W10: 60 mm, W11: 60 mm).
Example 6: Refer to FIG. 1 (W1: 50 mm, W2: 60 mm).
Example 7: Refer to FIG. 2 (W3: 8 mm, W4: 8 mm, W5: 12 mm, W6: 12 mm).
Example 8: Refer to FIG. 4 (W12: 1 mm, W13: 12 mm).

The white-colored portions in FIGS. 1 to 4 are recessed portions on the press dies, and the black-colored portions are the protruding portions. In other words, recessed deformation portions having the same shapes as the black-colored portions in the drawings are formed on the three-dimensional knitted fabrics. In addition, FIGS. 1 to 4 show repeating units of the press dies and do not limit the number of recessed deformation portions. In the Examples and Comparative Examples, the recessed deformation portions shown in FIGS. 1 to 4 are formed repeatedly in the knitted fabric warp direction and the knitted fabric weft direction. Further, pressing was carried out so that the vertical direction in FIGS. 1 to 4 matched the warp direction of the three-dimensional knitted fabrics.

### Example 9

Except that false-twisted yarns of 222-decitex 48-filament polyethylene terephthalate fibers (black dope-dyed yarns) were fed from two reeds (L1, L2) forming the knitted fabric of the front layer and the on-machine course was set to 24 courses/2.54 cm, a three-dimensional knitted material including recessed deformation portions having the various physical properties shown in Table 1 below was obtained in the same manner as in Example 1, and was used as an surface material for a seat.

### Example 10

Except that the on-machine course was set to 38 courses/2.54 cm, a three-dimensional knitted material including recessed deformation portions having the various physical properties in Table 2 below was obtained in the same manner as in Example 9, and was used as an surface material for a seat.

### Example 11

Except that recessed deformation portions were formed by embroidering the black-colored portions in FIG. 1 without heat pressing after heat setting, a three-dimensional knitted material including recessed deformation portions having the various physical properties in Table 2 below was obtained in the same manner as in Example 1, and was used as an surface material for a seat.

### Example 12

Except that recessed deformation portions were formed by embroidering the black-colored portions in FIG. 2 without heat pressing after heat setting, a three-dimensional knitted material including recessed deformation portions having the various physical properties in Table 2 below was obtained in the same manner as in Example 4, and was used as an surface material for a seat.

### Example 13

Except that recessed deformation portions were formed by embroidering the black-colored portions in FIG. 3 without heat pressing after heat setting, a three-dimensional knitted material including recessed deformation portions having the various physical properties in Table 2 below was obtained in the same manner as in Example 5, and was used as an surface material for a seat.

### Example 14

Except that recessed deformation portions were formed by embroidering the black-colored portions in FIG. 4 without heat pressing after heat setting, a three-dimensional knitted material including recessed deformation portions having the various physical properties in Table 2 below was obtained in the same manner as in Example 8, and was used as an surface material for a seat.

### Example 15

Except that recessed deformation portions were formed by embroidering the black-colored portions in FIG. 1 without heat pressing after heat setting, a three-dimensional knitted material including recessed deformation portions having the various physical properties in Table 2 below was obtained in the same manner as in Example 9, and was used as an surface material for a seat.

### Comparative Example 1

Except that the press die temperature was set to 220° C. and the press time was set to 10 s, a three-dimensional knitted material including recessed deformation portions having the various physical properties in Table 2 below was obtained in the same manner as in Example 9, and was used as an surface material for a seat.

### Comparative Example 2

Except that the press die temperature was set to 120° C. and the press time was set to 3 s, a three-dimensional knitted material including recessed deformation portions having the various physical properties in Table 2 below was obtained in the same manner as in Example 10, and was used as an surface material for a seat.

TABLE 1

| | Exam- | Exam- | Exam- | Exam- | Exam- | Exam- | Exam- | Exam- | Exam- |
|---|---|---|---|---|---|---|---|---|---|
| | ple 1 | ple 2 | ple 3 | ple 4 | ple 5 | ple 6 | ple 7 | ple 8 | ple 9 |
| Total fineness of fibers forming one stitch | 334 | 334 | 334 | 334 | 334 | 334 | 334 | 334 | 444 |
| in knitted fabric of front layer (decitex) | | | | | | | | | |
| Wale density (number of wales/2.54 cm) | 22 | 22 | 22 | 22 | 22 | 22 | 22 | 22 | 20 |
| Course density (number of courses/2.54 | 35 | 35 | 35 | 35 | 35 | 35 | 35 | 35 | 25 |
| cm) | | | | | | | | | |
| Recessed deformation portion thickness | 3.50 | 3.76 | 4.91 | 2.03 | 3.11 | 2.86 | 1.79 | 2.05 | 2.56 |
| (mm) | | | | | | | | | |
| Fabric thickness (mm) | 5.71 | 5.79 | 6.12 | 5.49 | 5.71 | 5.71 | 3.81 | 5.66 | 6.12 |
| Parameter A | 21.5 | 22.7 | 28.1 | 13.0 | 19.0 | 17.5 | 16.4 | 12.6 | 10.5 |
| Number of continuous wales in recessed | 346 | 346 | 346 | 4 | 61 | 346 | 7 | 1 | 315 |
| deformation portion | | | | | | | | | |
| Number of continuous courses in recessed | 1 | 3 | 10 | 7 | 48 | 69 | 11 | 551 | 1 |
| deformation portion on same wale | | | | | | | | | |
| Spacing in knitted fabric warp direction | 12 | 16 | 38 | 5 | 60 | 60 | 12 | — | 38 |
| between recessed deformation portions | | | | | | | | | |
| (mm) | | | | | | | | | |
| Stitch density | 14072 | 14072 | 14072 | 14072 | 14072 | 14072 | 14072 | 14072 | 10536 |
| Fluff due to hook-and-loop fastener in | 4 | 4.5 | 4.5 | 3.5 | 4 | 4 | 4 | 3.5 | 3 |
| warp direction (grade) | | | | | | | | | |
| Fluff due to hook-and-loop fastener in | 3.5 | 3.5 | 3.5 | 3 | 3.5 | 3.5 | 3 | 4 | 2.5 |
| weft direction (grade) | | | | | | | | | |
| Cushioning properties (grade) | 4.5 | 4.5 | 4.5 | 3.5 | 3.5 | 3 | 3 | 2.5 | 4.5 |
| Sideways falling properties (grade) | 4.5 | 4.5 | 4 | 3 | 4 | 4 | 4 | 2.5 | 4.5 |
| Slipperiness (grade) | 4 | 3.5 | 3.5 | 4 | 4 | 4 | 4 | 4 | 4.5 |

TABLE 2

| | Exam- | Exam- | Exam- | Exam- | Exam- | Exam- | Comparative | Comparative |
|---|---|---|---|---|---|---|---|---|
| | ple 10 | ple 11 | ple 12 | ple 13 | ple 14 | ple 15 | Example 1 | Example 2 |
| Total fineness of fibers forming one stitch | 444 | 334 | 334 | 334 | 334 | 444 | 444 | 444 |
| in knitted fabric of front layer (decitex) | | | | | | | | |
| Wale density (number of wales/2.54 cm) | 25 | 22 | 22 | 22 | 22 | 20 | 20 | 25 |
| Course density (number of courses/2.54 cm) | 41 | 35 | 35 | 35 | 35 | 25 | 25 | 41 |
| Recessed deformation portion thickness (mm) | 3.82 | 3.74 | 2.31 | 2.85 | 2.32 | 2.39 | 1.29 | 6.32 |
| Fabric thickness (mm) | 6.63 | 5.58 | 5.32 | 5.50 | 5.51 | 5.92 | 5.66 | 6.73 |
| Parameter A | 23.6 | 23.5 | 15.2 | 18.1 | 14.7 | 10.1 | 5.7 | 38.5 |
| Number of continuous wales in recessed | 394 | 346 | 4 | 61 | 1 | 315 | 315 | 394 |
| deformation portion | | | | | | | | |
| Number of continuous courses in recessed | 2 | 1 | 7 | 48 | 551 | 1 | 1 | 2 |
| deformation portion on same wale | | | | | | | | |
| Spacing in knitted fabric warp direction | 38 | 12 | 5 | 60 | — | 38 | 38 | 38 |
| between recessed deformation portions (mm) | | | | | | | | |
| Stitch density | 21598 | 14072 | 14072 | 14072 | 14072 | 10536 | 10536 | 21598 |
| Fluff due to hook-and-loop fastener in | 4.5 | 3.5 | 3 | 3.5 | 3 | 2.5 | 2 | 4.5 |
| warp direction (grade) | | | | | | | | |
| Fluff due to hook-and-loop fastener in | 4 | 3 | 2.5 | 3 | 3.5 | 2.5 | 1 | 4 |
| weft direction (grade) | | | | | | | | |
| Cushioning properties (grade) | 4.5 | 4.5 | 3.5 | 3.5 | 2.5 | 4.5 | 3.5 | 4.5 |
| Sideways falling properties (grade) | 4.5 | 5 | 3.5 | 4.5 | 3 | 5 | 5 | 1.5 |
| Slipperiness (grade) | 4 | 4 | 4 | 4 | 4 | 4.5 | 4.5 | 2 |

As indicated in Tables 1 and 2, in the surface materials for a seat comprising a three-dimensional knitted material including recessed deformation portions of Examples 1 to 15, wherein the parameter A was 6 or greater and 36 or less, fluff due to a hook-and-loop fastener (hook side), a sideways falling phenomenon during compression, and slipperiness of the seating portion were suppressed, and cushioning properties were satisfactory.

In Comparative Example 1, wherein the parameter A was less than 6, although cushioning properties were satisfactory and a sideways falling phenomenon and slipperiness were suppressed, fluff properties due to a hook-and-loop fastener was remarkably low.

In Comparative Example 2, the parameter A was excessively high at 39. Although fluff due to a hook-and-loop fastener was suppressed, a sideways falling phenomenon and slipperiness could not be suppressed.

### INDUSTRIAL APPLICABILITY

The surface material for a seat of the present invention is an surface material for a seat that can be arranged on a cushioning member such as a urethane pad to form a seat in a seat of a vehicle or furniture or can be stretched on a seat frame to form a lightweight and thin seat, has high cushioning properties and can suppress the occurrence of fluff at the same time, even when the surface is rubbed against hard protrusions such as hook portions of a hook-and-loop fastener, and can be suitably used to suppress slipping during seating.

1: A surface material for a seat, composed of a three-dimensional knitted material comprising a front-back two-layered knitted fabric having a front layer and a back layer and a connecting yarn connecting layers of the front-back two-layered knitted fabric, wherein the three-dimensional knitted material includes a recessed deformation portion on a front layer side, and a parameter A calculated by the following formula:
$$parameter A = course density ( courses / 2.54 cm ) \times recessed portion thickness ( mm ) / fabric thickness ( mm )$$
is 6 or greater and 36 or less.

2: The surface material for a seat according to claim 1, wherein the recessed deformation portion is formed across 5 or more continuous wales.

3: The surface material for a seat according to claim 1, wherein the recessed deformation portion is formed continuously across 60 courses or less on a same wale.

4: The surface material for a seat according to claim 1, wherein the three-dimensional knitted material includes a plurality of recessed deformation portions, and a spacing between recessed deformation portions closest to each other on a same wale is 10 mm or more and less than 300 mm.

5: The surface material for a seat according to claim 1, wherein a spacing between recessed deformation portions closest to each other on a same wale is 15 mm or more and less than 300 mm.

6: The surface material for a seat according to claim 1, wherein the recessed deformation portion is formed by fusion of fibers.

7: The surface material for a seat according to claim 5, wherein the recessed deformation portions are formed by fusion of fibers.

8: The surface material for a seat according to claim 1, wherein the recessed deformation portion is formed by embroidery or sewing.

9: The surface material for a seat according to claim 1, wherein a stitch density in a front layer of the three-dimensional knitted material is 11500 or greater and 23000 or less.

10: The surface material for a seat according to claim 9, wherein a stitch density in a front layer of the three-dimensional knitted material is 13000 or greater and 23000 or less.

11: A seat comprising the surface material for a seat according to claim 1.
